(19) United States
(12) Patent Application Publication
(10) Pub. No.: US 2006/0267897 A1
(43) Pub. Date: Nov. 30, 2006

(54) Driving method for display panel and driving device thereof

(76) Inventor: Che-Li Lin, Taipei City (TW)

Correspondence Address: J.C. Patens, Inc., Suite 250, 4 Venture, Irvine, CA, 92618, US

(21) Appl. No.: 11/249,925

(22) Filed: Oct. 12, 2005

(30) Foreign Application Priority Data
May 24, 2005 (TW) 94116836

(51) Int. Cl. G09G 3/36

(52) U.S. Cl. 345/96

(57) ABSTRACT

The present invention provides a driving method adapted for a display panel. The display panel has a plurality of data lines, in which each of the data lines respectively corresponds to multiple pixels. The driving method includes the following: the pixels of each of the data lines are driven with a plurality of frame times have a polarity distribution and are processed one by one, in which the polarity distribution corresponding to the pixels of the data lines can be the polarity distribution of the next frame time obtained by moving back a first pixel polarity of a first polarity distribution of a previous frame time and forming a last pixel polarity of a second polarity distribution of a next frame time, together with the moving forward of the polarity distribution of the remaining pixels of the previous frame time.

### CROSS-REFERENCE TO RELATED APPLICATION

This application claims the priority benefit of Taiwan application serial no. 94116836, filed on May 24, 2005. All disclosure of the Taiwan application is incorporated herein by reference.

### BACKGROUND OF THE INVENTION

1. Field of the Invention

The present invention relates to a driving method for a display panel and the driving device thereof, and particularly to a polarity inversion method for a display panel and the driving device thereof.

2. Description of Related Art

Nowadays, flat panel displays including thin film transistor liquid crystal display (TFT-LCD), low temperature polycrystalline silicon (LTPS) display, and organic light emitting diode (OLED) are being developed rapidly and continuously. Since an LCD panel is lighter, slimmer, and more compact with lower radiation and lower power consumption, it significantly saves room in offices and homes. In addition, the LCD further reduces viewer fatigue caused by the longtime viewing of the display.

With regard to LCD, the liquid crystal molecules for conducting and refracting color light beams should not be fixed under a certain voltage. If the liquid crystal molecules are fixed under a certain voltage for a relatively long time, even if the voltage were removed afterwards, they would lose their normal characteristics for rotation for obtaining different gray scales corresponding to the voltage variations. Therefore, the voltage should be changed back to the original state at intervals for protecting the integrity of the characteristics of the liquid crystal molecules from destruction. The voltages inside the LCD are divided into two types: positive polarity and negative polarity. When a voltage of a display electrode is higher than the voltage of a common electrode, it is referred to as “having a positive polarity”. On the other hand when a voltage of a display electrode is lower than the voltage of a common electrode, it is referred to as “having a negative polarity”.

The methods for inverting polarity in the driving methods for a conventional LCD panel are generally as described below. The voltages applied on the liquid crystal molecules are divided into two types as positive voltages and negative voltages. FIGS. 1A to 1D are schematic diagrams illustrating the conventional methods for inverting polarity for an LCD panel. Generally speaking, the methods for inverting polarity include the frame inversion as shown in FIG. 1A, the row inversion as shown in FIG. 1B, the column inversion as shown in FIG. 11C, and the dot inversion as shown in FIG. 1D. The foregoing methods for inverting polarity are different from each other in that the adjacent pixels having or not having identical polarity are different according to the foregoing methods for inverting polarity in which the polarity inversion of each pixel is generally synchronized with the scanning frame of the display panel. Frame inversion is so that all the pixels of a frame have same polarity. Nevertheless, the opposite polarity between adjacent frame scannings shall cause a viewer to likely perceive that the frames are flickering. In addition, cross-talk caused by the adjacent pixels having identical polarity is likely to occur. Row inversion is so that the pixels of each row and its adjacent row have polarities opposite to each other. Column inversion is so that the pixels of each column and its adjacent columns have polarities opposite to each other, which is also the method of the least power consumption. And dot inversion is so that the polarity of each pixel on the panel is opposite to the polarity of its adjacent pixels. At the present, dot inversion is more widely used since it is least likely to cause problems of flickering and cross-talk.

In recent years, to maintain the advantages of dot inversion having little flickering and cross-talk while consuming less power, the conventional dot inversion has been developed into other methods including one-line inversion, two-line inversion . . . to N-line inversion methods. FIGS. 2A and 2B are schematic diagrams respectively illustrating the polarity distribution and the scanning waveform of a conventional one-line inversion method in accordance with dot inversion for an LCD panel. FIGS. 3A and 3B are schematic diagrams respectively illustrating the polarity distribution and the scanning waveform of a conventional two-line inversion method in accordance with dot inversion. Similarly, the polarity distribution and the scanning waveform of an N-line inversion method can be obtained.

However, a problem may occur in the two-line inversion. For example, comparing the first scan line (horizontal) with the second scan line shown in FIG. 3B, it can be found that the electric charges accumulated at the pixels of the even scan lines (having direct ratio with the area of the data line waveform) are always more than the electric charges accumulated at the pixels of the odd scan lines. Consequently, the viewers would have the perception that the even scan lines are always darker than the odd scan lines for normally-white display panel. In other words, the frames may be viewed as having interleaved horizontal bright and dim lines. The problem of uneven brightness of horizontal lines would occur in two-line inversion to N-line inversion instead of one-line inversion.

Therefore, a driving method for avoiding the problems of flickering and cross-talk of conventional LCD panels and further avoiding interleaved bright and dim lines is highly demanded.

### SUMMARY OF THE INVENTION

To overcome the disadvantage of the conventional display panel, the present invention provides a driving method and a driving device thereof for efficiently solving the problem of interleaved bright and dim lines of the display panel.

An objective of the present invention is to provide a driving method adapted for a display panel. The driving method sequentially drives the pixels of each of the data lines with a plurality of polarity distributions in a frame time.

Another objective of the invention is to provide a driving device for driving a display panel.

Another objective of the invention is to provide a source driving device for driving a display panel.

A further objective of the invention is to provide a polarity generator for generating a plurality of polarity signals.

The present invention provides a driving method adapted for a display panel. The display panel has a plurality of data lines, and each of the data lines corresponds respectively to multiple pixels. The driving method includes the following: the pixels of each of the data lines are sequentially driven with a plurality of frame times having a plurality of polarity distributions, in which the polarity distribution corresponding to the pixels of the data lines is obtained by moving back a first pixel polarity in a first polarity distribution in a previous frame time, which becomes a last pixel polarity in a second polarity distribution in a next frame time, and the the remaining polarity distribution of the pixels in the previous frame time are further added and moved ahead for becoming the polarity distribution of the next frame time. And the rest may be arrived at by deduction.

According to the foregoing driving method of an embodiment of the present invention, with respect to the polarity distributions of the pixels of each data line, a last pixel polarity of a first polarity distribution of a previous frame time can be moved forward for becoming a first pixel polarity of a second polarity distribution of a next frame time, together with the moving backwards of the polarity distribution of the remaining pixels of the previous frame time and becoming the second polarity distribution of the next frame time. And the rest may be arrived at by deduction.

According to the foregoing driving method of an embodiment of the present invention, with respect to the polarity distributions of the pixels of each data line, the last pixel polarity of a second polarity distribution of a next frame time can be obtained by moving back and reversing polarity of a first pixel polarity of a first polarity distribution of a previous frame time and becoming the second polarity distribution of the next frame time, together with the moving forward of the polarity distribution of the remaining pixels of the previous frame time. And the rest may be arrived at by deduction.

According to the foregoing driving method of an embodiment of the present invention, the polarity distribution corresponding to the pixels of the data lines can be the first pixel polarity of the second polarity distribution of the next frame time obtained by moving forward a last pixel polarity of a first polarity distribution of a previous frame time and inverting its polarity and forming a second polarity distribution of a next frame time, together with the moving back of the polarity distribution of the remaining pixels of the previous frame time. And the rest may be arrived at by deduction.

According to an embodiment of the present invention, each of the foregoing polarity distribution is formed by a pixel having a first polarity and a pixel having a second polarity alternately interchanged sequentially.

According to an embodiment of the present invention, each of the foregoing polarity distribution is formed by N pieces of pixels having a first polarity and N pieces of pixels having a second polarity alternately interchanged sequentially, in which N≧2.

The present invention provides a driving device for a display panel. The driving device includes a timing sequence controller for providing a plurality of polarity signals to the driving device, and a plurality of source electrode driving device, in which each of the source electrode driving devices receives the polarity signals provided by the timing sequence controller. The timing sequence controller includes at least a polarity generator. The polarity generator includes a frame counter for receiving a frame starting signal, a polarity generation circuit for receiving a timing pulse signal and a selectively used reference polarity signal, a plurality of polarity signal lines connected to the polarity generation circuit, a multiplexer connected to the polarity generation circuit via the polarity signal lines, and selecting a plurality of polarity signals according to a signal from the frame counter.

The present invention provides a source electrode driving device. The source electrode driving device includes the polarity generator for receiving a frame starting signal, a timing pulse signal, and a selectively used reference polarity signal from the exterior of the source electrode driving device; and an internal polarity signal and an internal timing sequence of the source electrode driving device are provided.

The present invention provides a polarity generator. The polarity generator includes a frame counter for receiving a frame starting signal, a polarity generation circuit for receiving a timing pulse signal and a selectively used reference polarity signal, a plurality of polarity signal lines connected to the polarity generation circuit; a multiplexer is connected to the polarity generation circuit via the polarity signal lines, and is outputted selectively a plurality of polarity signals according to a signal from the frame counter.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A to 1D are schematic diagrams illustrating a conventional method for inverting polarity for an LCD panel.

FIGS. 2A and 2B are schematic diagrams respectively illustrating the polarity distribution and the scanning waveform of a one-line inversion of a conventional dot inversion method for a display panel.

FIGS. 3A and 3B are schematic diagrams respectively illustrating the polarity distribution and the scanning waveform of a conventional two-line inversion of a dot inversion method for a display panel.

FIGS. 4A and 4B are schematic diagrams respectively illustrating the polarity distribution and the scanning waveform of a two-line inversion of the display panel, according to an embodiment of the present invention.

FIGS. 5A and 5B are schematic diagrams respectively illustrating the polarity distribution and the scanning waveform of a two-line inversion of the display panel, according to another embodiment of the present invention.

FIG. 6 is a block diagram illustrating a driving device according to an embodiment of the invention.

FIG. 7 is a block diagram illustrating a source electrode driving device according to an embodiment of the invention.

FIG. 8 is a block diagram illustrating a polarity generator according to an embodiment of the invention.

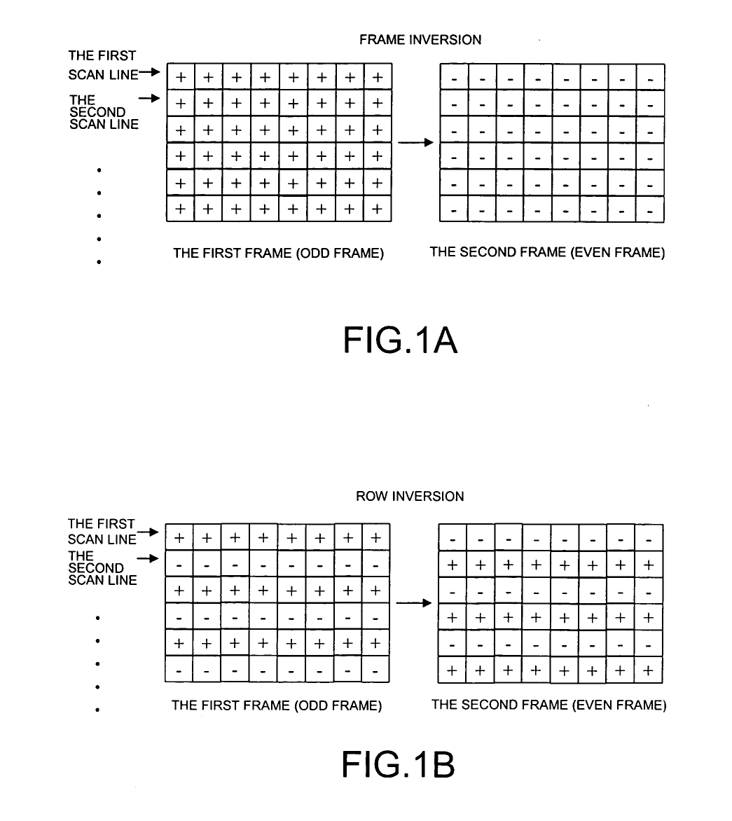

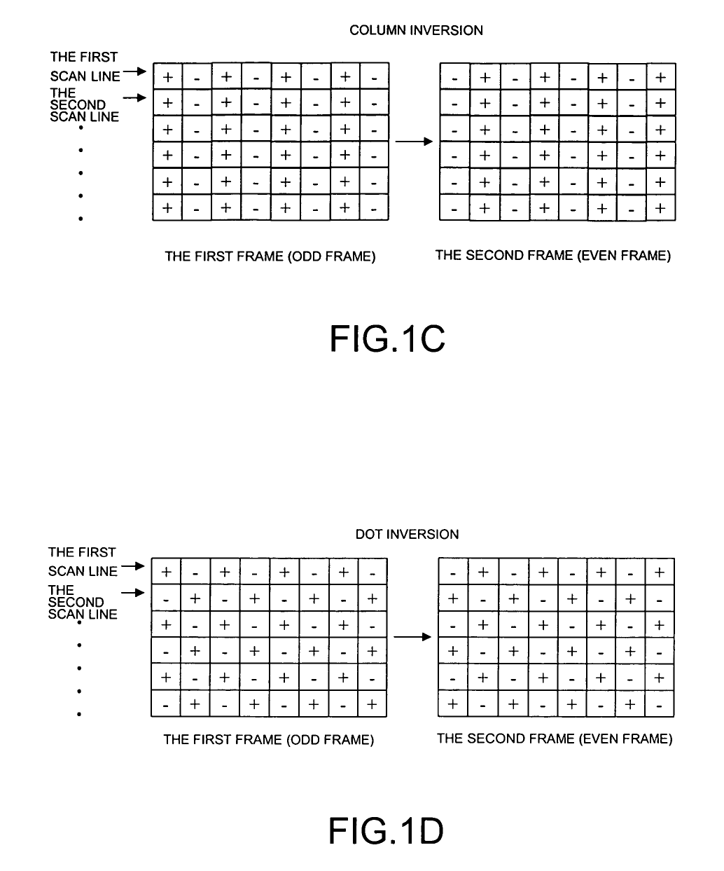

### DESCRIPTION OF THE PREFERRED EMBODIMENTS

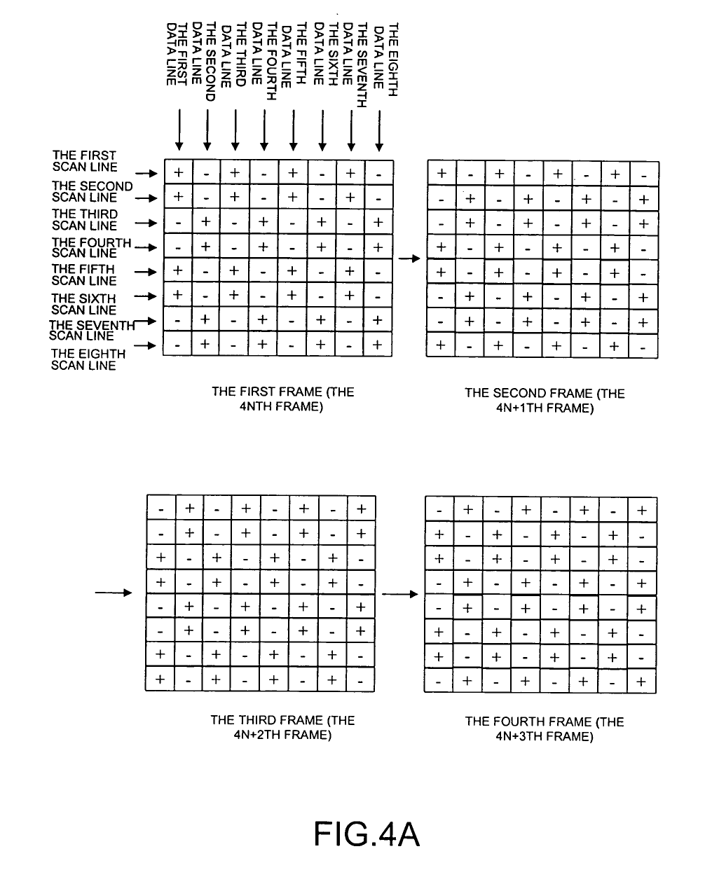

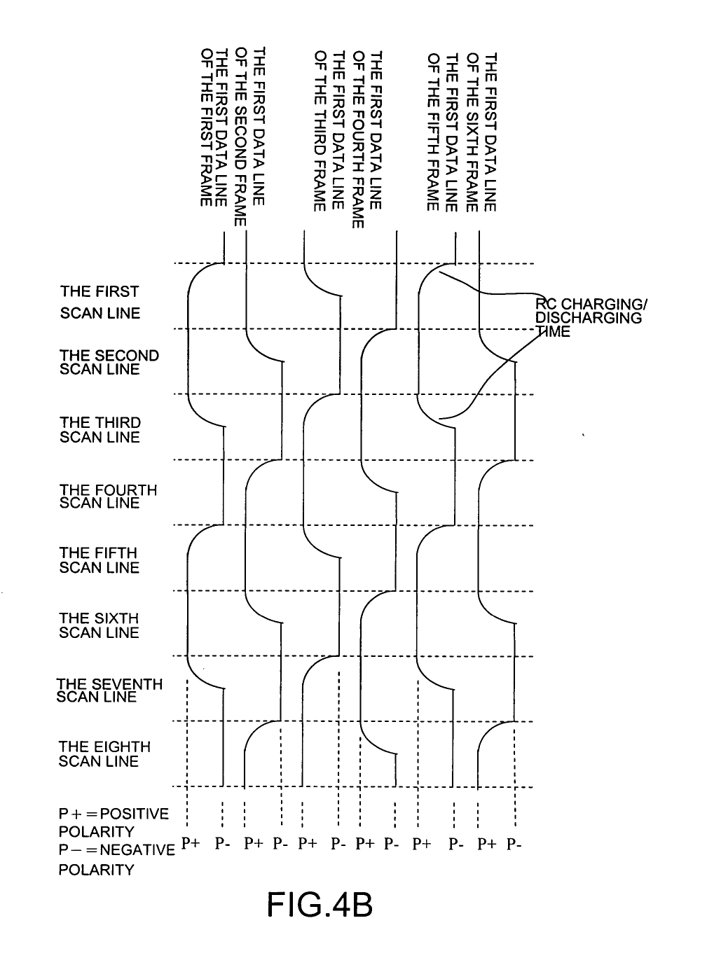

FIGS. 4A and 4B are schematic diagrams respectively illustrating the polarity distribution and the scanning waveform of a two-line inversion according to an embodiment of the display panel of the present invention. As shown in FIG. 4A, according to a 8×8 sub-pixel matrix (8 data lines×8 scan lines) inversion method, the polarity distribution of the first to the eighth scan lines of the first data line is according to the following display timing sequence: 8 7 6 5 4 3 2 1

(−,−,+,+,−,−,+,+) the 4N^{th} frame time

(−,+,+,−,−,+,+,−) the 4N+1^{th} frame time

(+,+,−,−,+,+,−,−) the 4N+2^{th} frame time

(+,−,−,+, +,−,−,+) the 4N+3^{th} frame time

(−,−,+,+,−,−,+,+) the 4N+4^{th} frame time

. . .

And the rest are arrived at by deduction, in which the figures marked over the polarity distribution are the corresponding codes for the first data line.

It is determined from the above polarity distribution, using the 4N^{th} frame time as an example, the polarity distribution of the 4N+1^{th} frame time is to:
1. move the rightmost pixel polarity of the polarity distribution of the 4N^{th} frame time (the pixel polarity of the first scan line of the first data line) to the left to be a leftmost pixel polarity of the polarity distribution of the 4N+1^{th} frame time (the pixel polarity of the eighth scan line of the first data line); and
2. move the remaining polarity distribution of the 4N^{th} frame time (the pixel polarities of the eighth to the second scan lines of the first data line) to the right to be the pixel polarity distribution of the seventh to the first scan lines of the first data line of the 4N+1^{th} frame time. Therefore, the polarity distribution of the 4N+1^{th} frame time is then obtained.
   Furthermore, it is to be noted that the polarity distribution of the 4N^{th} frame time is the same with the polarity distribution of the 4N+4^{th} frame time; therefore, the polarity distribution is repeated at every four frame times.

In summary, according to the pixel polarity distribution of each data line, the polarity distribution of the next frame time is obtained by moving back the first pixel polarity of the polarity distribution of the previous frame time as the last pixel polarity of the polarity distribution of the next frame time, together with the remaining pixel polarities of the previous frame time being moved forward.

According to an embodiment of the invention, each of the polarity distribution is formed by a pixel having a first polarity and a pixel having a second polarity alternately interchanged sequentially.

According to an embodiment of the invention, each of the polarity distribution is formed by N pieces of pixels having a first polarity and N pieces of pixels having a second polarity alternately interchanged sequentially, in which N≧2.

Now referring to FIG. 4B, it can be known by analyzing the variation of the pixel polarity distribution at the intersection point of the first data line, the first scan line, and the second scan line, that when switching from the first frame to the fourth frame, the electrical status of the pixel of the first scan line corresponding to these four frames are Charging, Positive, Discharging, and Negative respectively. The electrical status of the pixel of the second scan line corresponding to these four frames are Positive, Discharging, Negative, and Charging respectively. Therefore, corresponding to the first frame to the fourth frame, the average electric charge distribution (the average value of the waveforms) of the pixel of the first scan line is equivalent to the average electric charge distribution of the pixel of the second scan line. In other words, upon viewing of any four consecutive frames and because of the persistence of vision, a viewer shall perceive an equal average brightness of the first scan line (horizontal) and the second scan line (horizontal). Similarly, according to any of the first scan line to the eighth scan line, any four consecutive frames shall have four electrical status of Charging, Positive, Discharging, and Negative. Therefore, after viewing any four consecutive frames, the viewer shall perceive an equal average brightness of all horizontal lines. For example, when a display frame is a repetitive image of a same color or the display frame is fixed as a same image (such as a screen background), the present invention is able to efficiently solve the problem of interleaved bright and dim lines of the conventional displays.

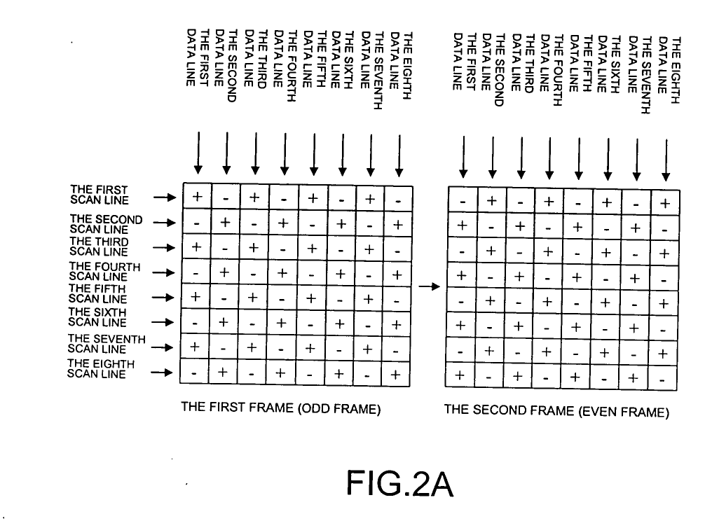

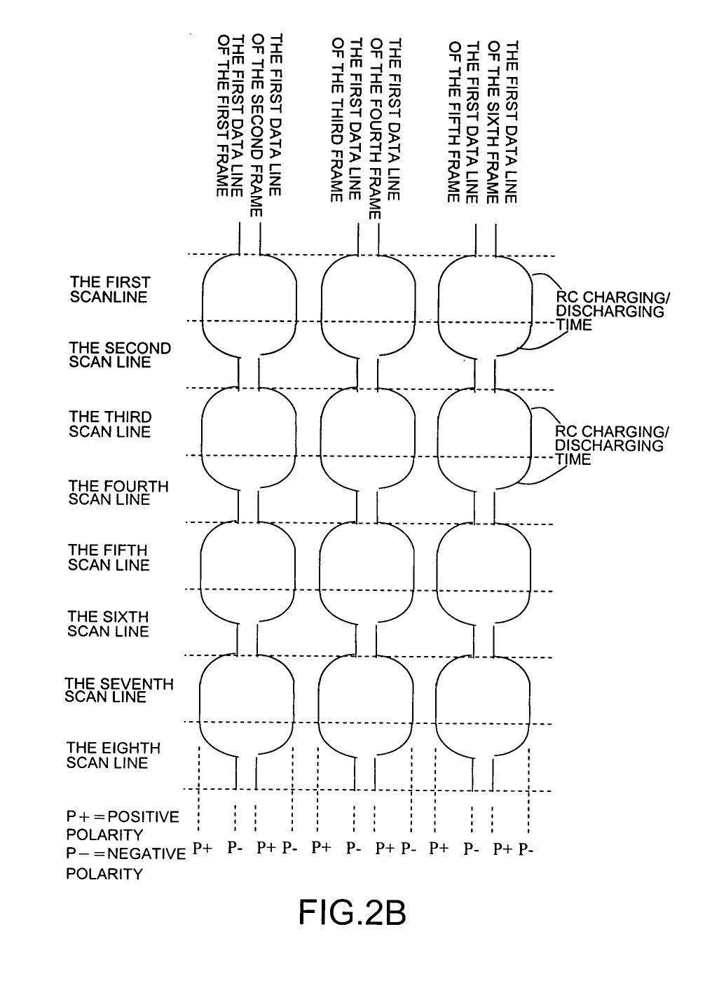

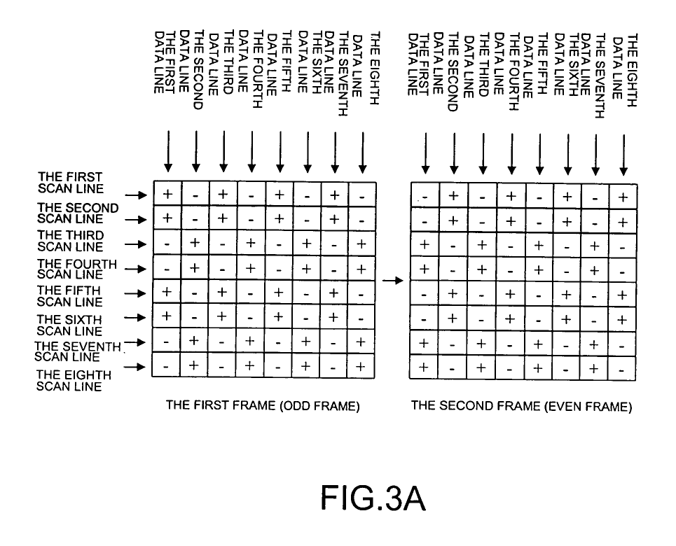

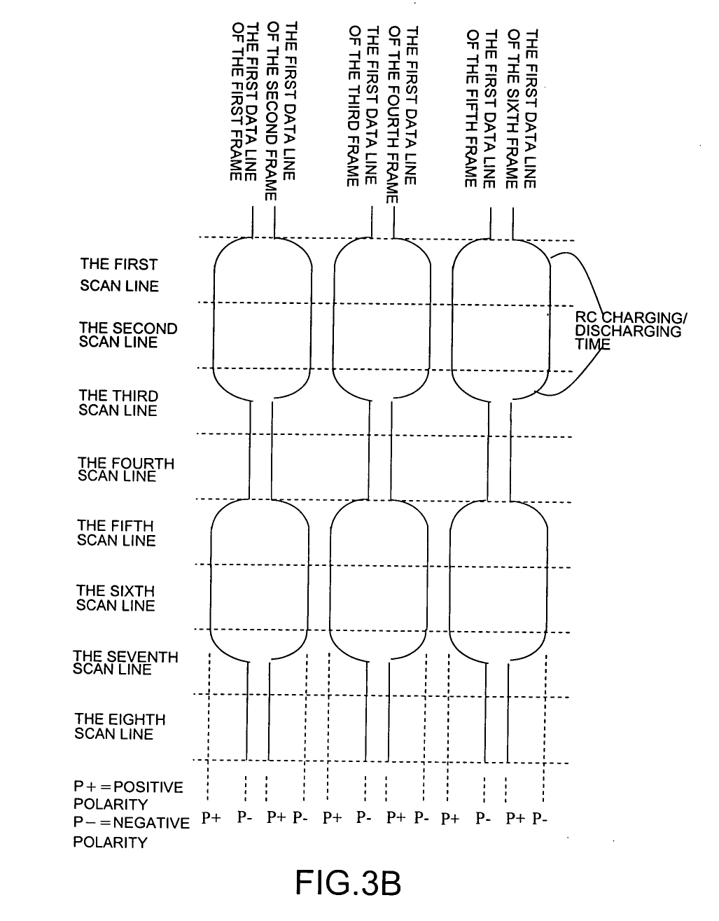

Also referred to FIG. 4B, according to a first data line or any data line of any first frame, it can be known that the time between Charging and Discharging a capacitor is about twice the time needed by a conventional dot inversion method illustrated in FIG. 2B. Therefore, the present invention inputs a comparatively lower voltage to obtain a comparatively higher brightness which is also lower in power consumption.

It should be noted that, all of the pixel polarities of the FIG. 4A are inverted every two frames. The alternating polarity variation provides a relatively balanced visual perception to the viewers. The frame brightness looks stable and balanced without flickering. Therefore, the driving method of the present invention provides an optimal display gray scale for a frame.

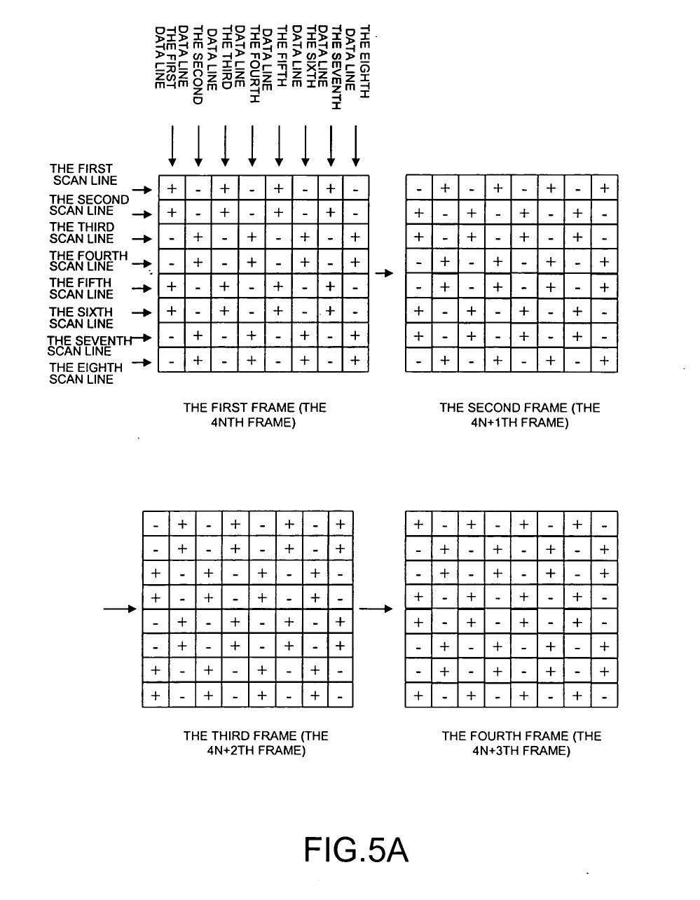

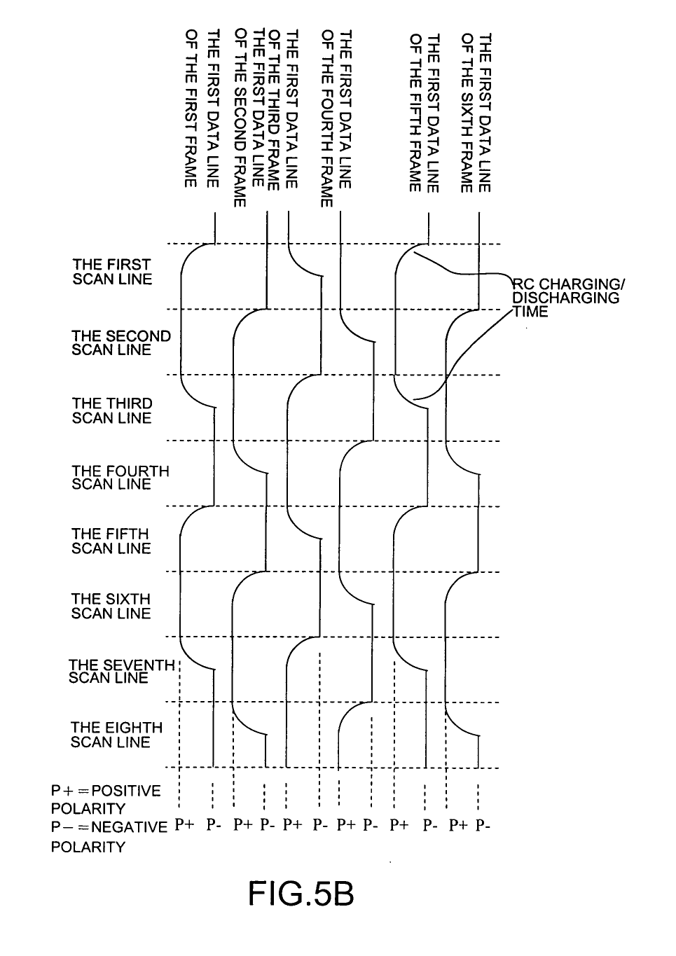

FIG. 5A is a schematic diagram illustrating the polarity distribution of a two-line inversion according to another embodiment of the display panel of the present invention. As shown in FIG. 5A, the polarity distribution of the first to the eighth scan lines of the first data line is shown as below in the following frame timing sequence: 8 7 6 5 4 3 2 1

(−,−,+,+,−,−,+,+) the 4N^{th} frame time

(−,+,+,−,−,+,+,−) the 4N+1^{th} frame time

(+,+,−,−,+,+,−,−) the 4N+2^{th} frame time

(+,−,−,+, +,−,−,+) the 4N+3^{th} frame time

(−,−,+,+,−,−,+,+) the 4N+4^{th} frame time

. . .

And the rest are arrived at by deduction, in which the figures marked over the polarity distribution are the corresponding codes for the first data line.

It can be seen from the above polarity distribution, using the 4N^{th} frame time as an example, the polarity distribution of the 4N+1^{th} frame time is to:
1. move the leftmost pixel polarity of the polarity distribution of the 4N^{th} frame time (the pixel polarity of the eighth scan line of the first data line) to the right to be a rightmost pixel polarity of the polarity distribution of the 4N+1^{th} frame time (the pixel polarity of the first scan line of the first data line).
2. move the remaining polarity distribution of the 4N^{th} frame time (the pixel polarities of the seventh to the first scan lines of the first data line) to the left to be the pixel polarity distribution of the eighth to the second scan lines of the first data line of the 4N+1^{th} frame time. Therefore, the polarity distribution of the 4N+1^{th} frame time is then obtained.
   Furthermore, it is to be noted that the polarity distribution of the 4N^{th} frame time is the same with the polarity distribution of the 4N+4^{th} frame time, in which the polarity distribution is repeated every four frame times.

In summary, the polarity distribution of the next frame time can be obtained by moving forward the last pixel polarity of the polarity distribution of the previous frame time to be the first pixel polarity of the polarity distribution of the next frame time, together with the moving back of the remaining pixel polarity distribution of the previous frame time.

According to an embodiment of the invention, each of the polarity distribution is formed by a pixel having a first polarity and a pixel having a second polarity alternately interchanged sequentially.

According to an embodiment of the invention, each of the polarity distribution is formed by N pieces of pixels having a first polarity and N pieces of pixels having a second polarity alternately interchanged sequentially, in which N≧2.

Now referring to FIG. 5B, it can be known, by analyzing the variation of the pixel polarity distribution at the intersection point of the first data line, the first scan line, and the second scan line, as is changed from the first frame to the fourth frame, the electrical status of the pixel of the first scan line corresponding to these four frames are Charging, Negative, Discharging, and Positive respectively; the electrical status of the pixel of the second scan line corresponding to these four frames are Positive, Charging, Negative, and Discharging respectively. Therefore, according to the first frame to the fourth frame, the average electric charge distribution (the average value of the waveforms) of the pixel of the first scan line is equivalent to the average electric charge distribution of the pixel of the second scan line. In other words, upon viewing of any four consecutive frames and because of the persistence of vision, a viewer shall perceive an equal average brightness of the first scan line (horizontal) and the second scan line (horizontal). Similarly, corresponding to any of the first scan line to the eighth scan line, any four consecutive frames have four electrical status of Charging, Positive, Discharging, and Negative. Therefore, upon viewing of any four consecutive frames, the viewer shall perceive an equal average brightness of all horizontal lines. For example, when a display frame is a repetitive frame of the same color, or the display frame is fixed as a same frame (such as a screen background), the present invention is able to efficiently solve the problem of interleaved bright and dim lines of the conventional displays.

Also referring to FIG. 5B, corresponding to a first data line or any data line of any first frame, it can be known that the time between Charging and Discharging a capacitor is about twice the time needed by a conventional dot inversion method as illustrated in FIG. 2B. Therefore, the present invention inputs a comparatively lower voltage to obtain a comparatively higher brightness that is also lower in power consumption.

It should be noted that, all of the pixel polarities of FIG. 5A are inverted every two frames. Such an interleaving polarity variation is relatively even to the visual perception of the viewers. The brightness of the frames looked stable and uniform without flickering. Therefore, the driving method of the present invention provides an optimal display gray scale for a frame.

Therefore, according to the foregoing embodiments, the present invention further provides a driving method for a display panel. The display panel has a plurality of data lines, and each of the data lines corresponds respectively to a plurality of scan lines and the pixels thereof. The driving method includes the following: the pixels of each of the data lines are driven with a plurality of frame times which are polarly distributed and processed one by one, and in which the polarity distribution corresponding to the pixels of the data lines is the polarity distribution of the next frame time obtained by moving back a first pixel polarity of a first polarity distribution of a previous frame time and forming a last pixel polarity of a second polarity distribution of a next frame time, together with the moving forward of the polarity distribution of the remaining pixels of the previous frame time.

Similarly, according to the foregoing embodiments, the present invention further provides another driving method for a display panel. The display panel has a plurality of data lines, and each of the data lines corresponds respectively to a plurality of pixels. The driving method includes the following: the pixels of each of the data lines are driven corresponding to an occuring frame time with a plurality of polarity distributions, and in which, with respect to the polarity distributions of the pixels of the data lines, a last pixel polarity of a first polarity distribution of a previous frame time is moved forward to become a first pixel polarity of a second polarity distribution of a next frame time, further adding on the moving backward of the remaining pixel polarity distribution of the previous frame time is the second polarity distribution of the next frame time. And the rest may be arrived at by deduction.

According to an embodiment of the present invented driving method, the polarity distribution corresponding to the pixels of the data lines is the last pixel polarity of the second polarity distribution of the next frame time obtained by the moving back of a first pixel polarity of a first polarity distribution of a previous frame time and the inverting of its polarity and the forming of a second polarity distribution of a next frame time, together with the moving forward of the polarity distribution of the remaining pixels of the previous frame time. And the rest may be arrived at by deduction.

According to an embodiment of the present invented driving method, the polarity distribution corresponding to the pixels of the data lines is the first pixel polarity of the second polarity distribution of the next frame time obtained by the moving forward of a last pixel polarity of a first polarity distribution of a previous frame time and the inverting of its polarity and the forming of a second polarity distribution of a next frame time, together with the moving back of the polarity distribution of the remaining pixels of the previous frame time. And the rest may be arrived at by deduction.

According to an embodiment of the present invention, each of the polarity distribution is formed by a pixel having a first polarity and a pixel having a second polarity alternately interchanged sequentially.

According to an embodiment of the present invention, each of the polarity distribution is formed by N pieces of pixels having a first polarity and N pieces of pixels having a second polarity alternately interchanged sequentially, in which N≧2.

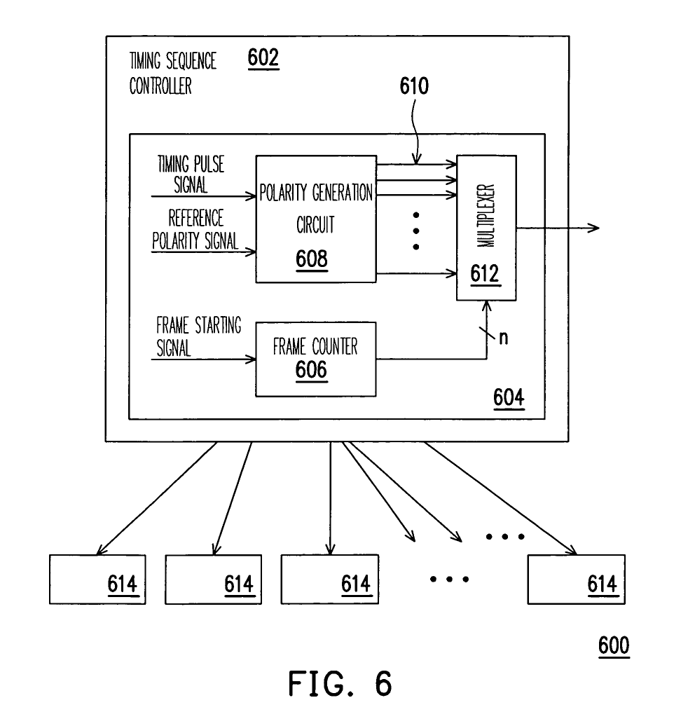

Referring to FIG. 6, a driving device 600 according to an embodiment of the present invention is provided, in which the driving device 600 is adapted for a display panel. The driving device includes a timing sequence controller 602 for providing a plurality of polarity signals to the driving device 600, and a plurality of source electrode driving devices 614, in which each of the source electrode driving devices 614 receives the polarity signals provided by the timing sequence controller 602. The timing sequence controller 602 includes at least a polarity generator 604, in which the polarity generator 604 includes a frame counter 606 for receiving a frame starting signal, a polarity generation circuit 608 for receiving a timing pulse signal and a selectively used reference polarity signal, a plurality of polarity signal lines 610 connected to the polarity generation circuit 608, a multiplexer 612 connected to the polarity generation circuit 608 via the polarity signal lines 610, and a plurality of polarity signals are selectively outputted corresponding to a signal from the frame counter 606.

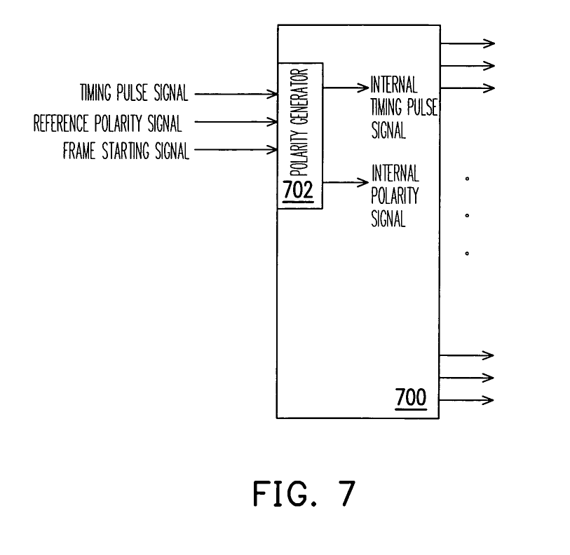

Referring to FIG. 7, a source electrode driving device 700 for driving a display panel is provided according to an embodiment of the present invention, in which the source electrode driving device 700 includes a polarity generator 702. The polarity generator 702 receives a frame starting signal, a timing pulse signal, and a selectively used reference polarity signal from the exterior of the source electrode driving device 700. And an internal polarity signal and a internal timing sequence of the source electrode driving device 700 are provided.

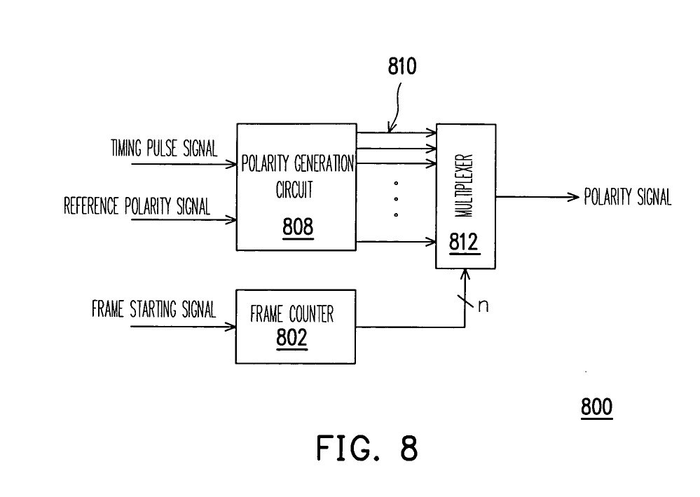

Referring to FIG. 8, a polarity generator 800 is provided according to an embodiment of the present invention, in which the polarity generator 800 includes a frame counter 802 for receiving a frame starting signal, a polarity generation circuit 808 for receiving a timing pulse signal and a selectively used reference polarity signal, a plurality of polarity signal lines 810 connected to the polarity generation circuit 808, a multiplexer 812 connected to the polarity generation circuit 808 via the polarity signal lines 810 and outputs a plurality of polarity signals selectively corresponding to a signal from the frame counter 802.

Other modifications and adaptations of the above-described preferred embodiments of the present invention may be made to meet particular requirements. This disclosure is intended to exemplify the invention without limiting its scope. All modifications that incorporate the invention disclosed in the preferred embodiment are to be construed as coming within the scope of the appended claims or the range of equivalents to which the claims are entitled.

What is claimed is:

1. A driving method, adapted for a display panel having a plurality of data lines, wherein each of the data lines corresponds respectively to a plurality of pixels, comprising:
driving the pixels of each of the data lines using a plurality of frame times having a polarity distribution and processing one by one, wherein the polarity distribution corresponds to the pixels of the data lines is a polarity distribution of the next frame time obtained by moving back a first pixel polarity of a first polarity distribution of a previous frame time and forming a last pixel polarity of a second polarity distribution of a next frame time, together with moving forward of the polarity distributions of the remaining pixels of the previous frame time.

2. The driving method according to claim 1, wherein the polarity distribution corresponding to the pixels of the data lines is the second polarity distribution of the next frame time obtained by moving forward a last pixel polarity of a first polarity distribution of a previous frame time and forming a first pixel polarity of a second polarity distribution of a next frame time, together with the moving back of the polarity distribution of the remaining pixels of the previous frame time, thereby becoming the second polarity distribution of the next frame time.

3. The driving method according to claim 1, wherein the polarity distribution corresponding to the pixels of the data lines is the second polarity distribution of the next frame time obtained by moving backward and reversing polarity of a first pixel polarity of a first polarity distribution of a previous frame time and forming a last pixel polarity of a second polarity distribution of a next frame time, together with the moving forward of the polarity distribution of the remaining pixels of the previous frame time, thereby becoming the second polarity distribution of the next frame time.

4. The driving method according to claim 1, wherein the polarity distribution corresponding to the pixels of the data lines is the last pixel polarity of the second polarity distribution of the next frame time obtained by the moving back of a first pixel polarity of a first polarity distribution of a previous frame time and the inverting of its polarity and the forming of a second polarity distribution of a next frame time, together with moving forward of the polarity distribution of the remaining pixels of the previous frame time.

5. The driving method according to claim 1, wherein each of the polarity distribution is formed by a pixel having a first polarity and a pixel having a second polarity alternately interchanged sequentially.

6. The driving method according to claim 1, wherein each of the polarity distribution is formed by N pieces of pixels having a first polarity and N pieces of pixels having a second polarity alternately interchanged sequentially, wherein N≧2.

7. A driving device, adapted for a display panel, comprising:
a timing sequence controller, for providing a plurality of polarity signals, the timing sequence controller comprising at least a polarity generator, wherein the polarity generator having:
a frame counter, for receiving a frame starting signal;
a polarity generation circuit, for receiving a timing pulse signal; and
a plurality of polarity signal lines, connected to the polarity generation circuit;
a multiplexer, connected to the polarity generation circuit via the polarity signal lines and outputting selectively a plurality of polarity signals
according to a signal from the frame counter; and
a plurality of source electrode driving devices, wherein each of the source electrode driving devices receiving the polarity signals provided by the timing sequence controller.

8. The driving device according to claim 7, wherein the polarity generation circuit comprises of receiving a reference polarity signal.

9. A source electrode driving device comprising:
a polarity generator, wherein the polarity generator receiving a frame starting signal and a first timing pulse signal, and providing a polarity signal and a second timing sequence of the source electrode driving device.

10. The source electrode driving device according to claim 9, wherein the polarity generator further comprises a selectively used reference polarity signal.

11. A polarity generator, comprising:
a frame counter, for receiving a frame starting signal;
a polarity generation circuit, for receiving a timing pulse signal;
a plurality of polarity signal lines, connected with the polarity generation circuit; and
a multiplexer, connected to the polarity generation circuit via the polarity signal lines and selecting a plurality of polarity signals according to a signal from the frame counter.

12. The polarity generator according to claim 11, wherein the polarity generation circuit further comprises a selectively used reference polarity signal.
